(19) United States
(12) Patent Application Publication
(10) Pub. No.: US 2002/0172734 A1
(43) Pub. Date: Nov. 21, 2002

(54) Part removal tool

(76) Inventor: Karl O. Stevens, Kingsley, MI (US)

Correspondence Address: Waters & Morse, P.C., 400 Ledyard Building, 125 Ottawa Avenue, NW, Grand Rapids, MI, 49503, US

(21) Appl. No.: 09/800,002

(22) Filed: Mar. 5, 2001

Related U.S. Application Data
(60) Provisional application No. 60/186,766, filed on Mar. 3, 2000.

(51) Int. Cl. B29C 33/46

(52) U.S. Cl. 425/437; 425/438

(57) ABSTRACT

A part removal tool for removing a resilient molded tubular part from a mold core first clamps the molded part on a cup removal tool at one end of the part and then inflates the part to separate the part from a mold core. The part removal tool includes a protective housing having spaced protective side plates that protect interior switches, conduits and actuators, while providing easy connections with exterior quick release fittings. The tool employs replaceable clamps and part removal cups so that the tool can be used for a variety of parts of different sizes and shapes. An extendable part ejector rod can be used to facilitate removal of a part from a mold core.

### CROSS-REFERENCES TO RELATED APPLICATIONS

This is a continuing non-provisional application based on and claiming the filing priority of co-pending provisional patent application Serial. No. 60/186,766, filed Mar. 3, 2000.

### STATEMENT REGARDING FEDERALLY SPONSORED RESEARCH OR DEVELOPMENT

Not Applicable.

### BACKGROUND OF THE INVENTION

Large diameter flexible tubes having convolutions in the tubes are used for a number of applications in automotive and other fields. These are typically formed by injection molding wherein a core is positioned between severable halves of a mold and molten rubber is injected between the core and the mold halves.

A problem with molding products in this manner is that it is difficult to remove the finished product from the mold core after the product is formed. A part removal tool can be used for this purpose. A part removal tool includes a cup that fits closely over the mold core in between the part and the mold core, and a clamp that clamps the part on the cup. Air is then injected into the cup and this inflates the part so that the part becomes dislodged from the convolutions in the mold. The cup part is then pulled off the mold by withdrawing the cup and clamped edge of the part away from the mold core.

A problem with prior part removal tools is that a separate tool had to be manufactured for each mold core size. Further, the part removal tools had exposed electrical cable and pneumatic tubes, and these were subject to damage during use. Prior product removal tools also were complicated, made of a number of parts, and structurally weak. An object of the present invention is to provide an improved part removal tool that is simple, strong, encloses the pneumatic hoses and electrical cables and, most importantly, accommodates a number of different sizes of part removal cups for different sizes of mold cores.

### SUMMARY OF THE INVENTION

In accordance with the present invention, a part removal tool for removing a molded elastic tubular part from a mold core comprises a housing having protective side plates spaced on each side of an open interior. The housing has an open front end. A handle is mounted to the plates at a rear end of the tool. An enlarged recess in the side plates adjacent the front end of the tool makes it possible to install a number of different part removal cups having substantially different outer dimensions in the tool. A part removal cup manifold is mounted between the plates at a rear end of the recess, the manifold having an inlet for pressurized gas and one or more outlets for pressurized gas. A part removal cup is removably mounted in the housing in the enlarged recess between the plates, the cup having an open front end facing outwardly from an open interior toward the open front end of the housing. The part removal cup has relatively thin peripheral sidewalls surrounding the open front end such that the sidewalls conform with and fit closely over a specified mold core. The part removal cup has a rear end mounted in the housing in sealed relationship with the manifold outlet, the rear end having one or more openings therein that provide sealed communication between the manifold outlet and the open interior of the cup. A clamp is movably and removably mounted in the housing adjacent the open end of the part removal cup for movement between an open position, wherein the clamp is spaced away from the cup sufficiently that the cup can be inserted between a molded product and a mold core, and a closed position, wherein the clamp clamps an end of the product on the cup after the cup has been inserted on the mold core the clamp having a clamping surface compatible with the adjacent exterior surface of the part removal cup. A clamp actuator opens and closes the clamp. A cup air actuator injects pressurized gas through the manifold to the cup to separate a clamped part from a mold core.

The tool housing and its protective side plates protect switches, conduits, and actuators mounted in the housing, while quick release fittings exterior to the housing facilitate removal and installation of electrical and pneumatic lines from the tool.

The part removal cup is bolted in the housing to the manifold and is removable and replaceable with a different cup for a different molding application. The clamp has clamping elements that also are easily removable for installing different clamping elements that are compatible with different part removal cups.

The tool can also include an extendable part ejection rod that extends outwardly through the cup to push the mold core away from the molded part clamped to the end of the part removal cup.

These and other features of the present invention are apparent from the preferred embodiment of the invention described below and shown in the appended drawings.

### BRIEF DESCRIPTION OF THE DRAWINGS

FIG. 1 is a perspective view of a tube molding press employing the part removal tool of the present invention.

FIG. 2 is a perspective view of the part removal tool of the present invention.

FIG. 3 is a side-elevational view of the part removal tool of the present invention, partially broken away to show interior components.

FIG. 4 is a fragmentary view showing the part clamping mechanism of the present invention.

FIG. 5 is a pictorial side-elevational view showing removal of a part by injection of pressurized air between the part and the mold core.

FIG. 6 is a perspective view of an alternative embodiment of the present invention employing a core bar to assist the removal of the part from the mold core.

FIG. 7 is a side-elevational view of the part removal tool of the present invention, showing the various electrical and pneumatic lines in schematic form.

FIG. 8 is a partial plan view of the part removal tool of FIG. 7.

FIG. 9 is a side-elevational view of the side plate of the part removal tool of the present invention.

### DETAILED DESCRIPTION OF PREFERRED EMBODIMENTS

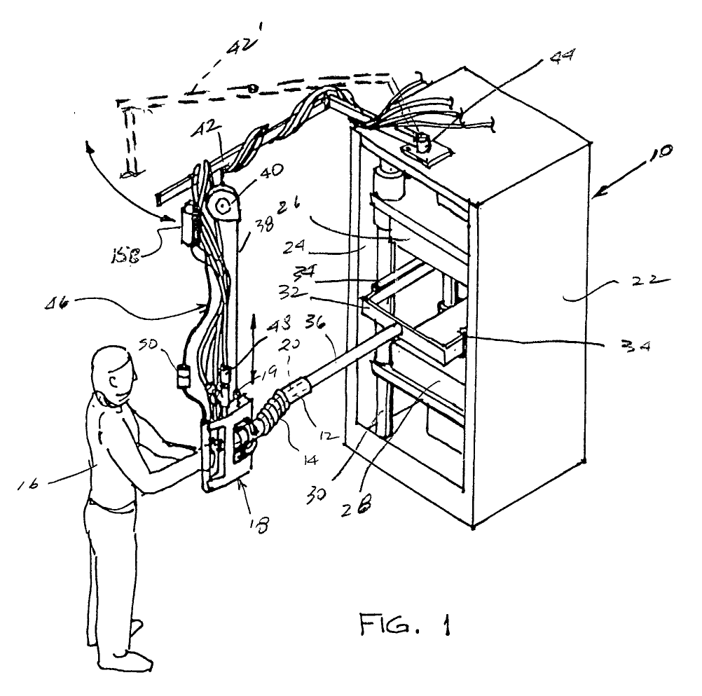

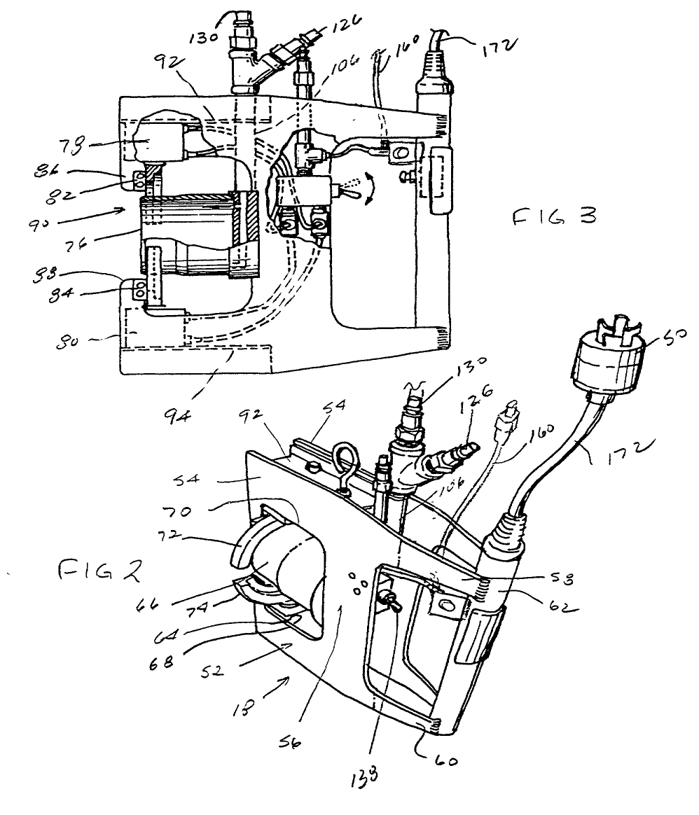

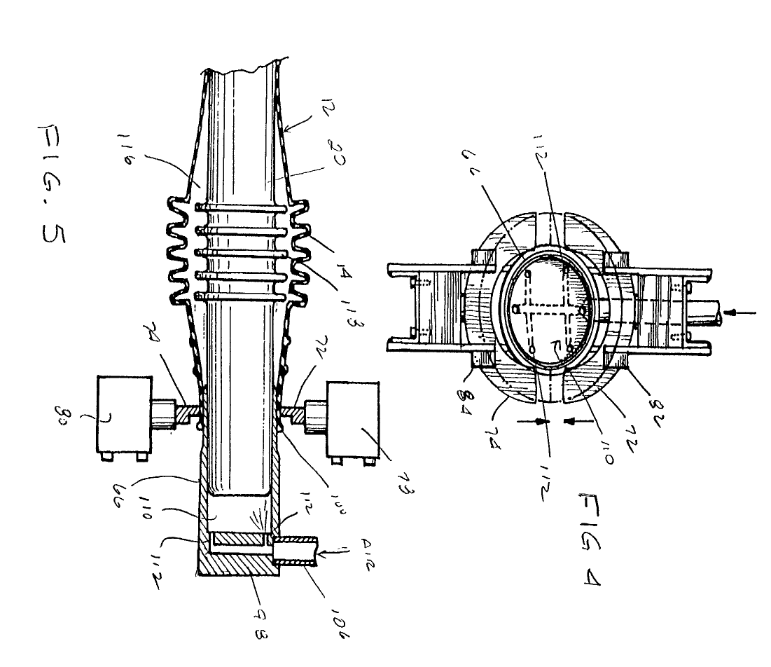

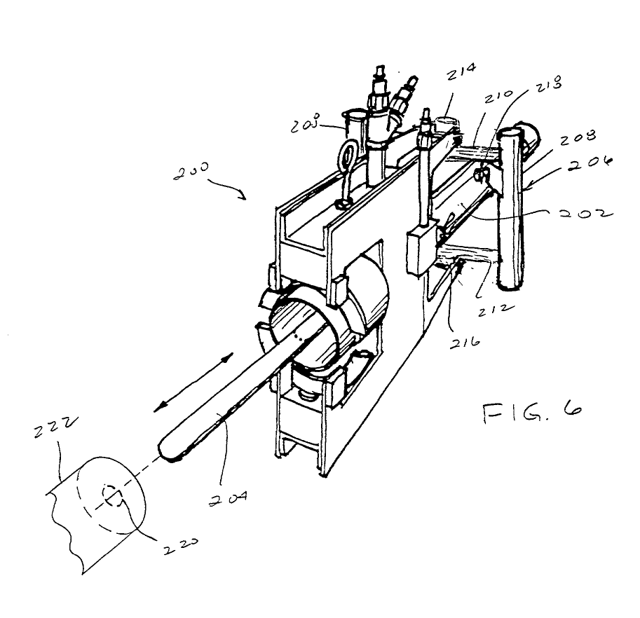

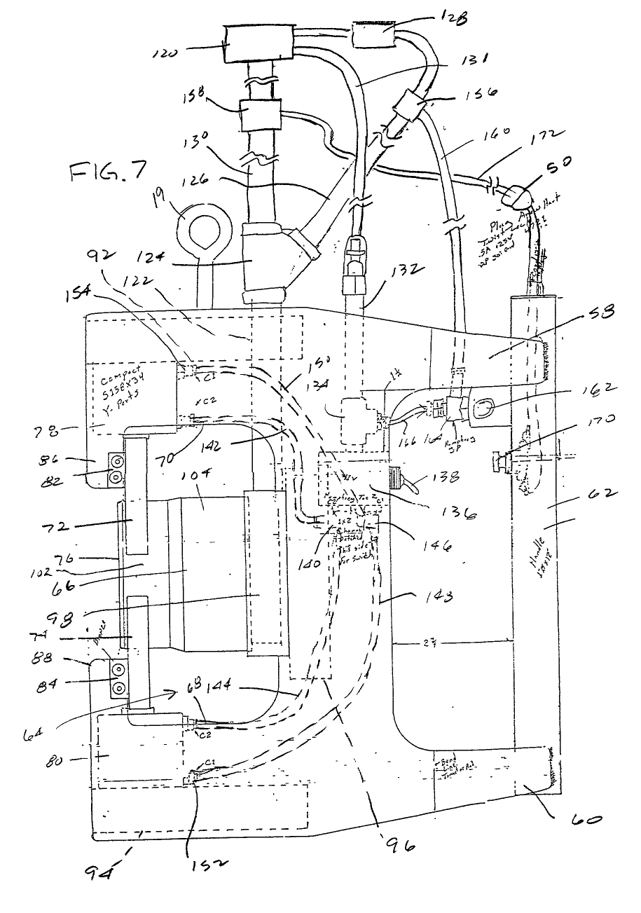

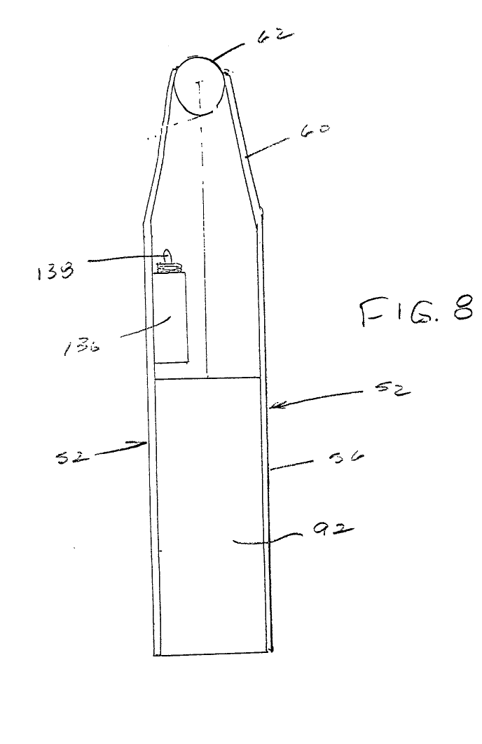

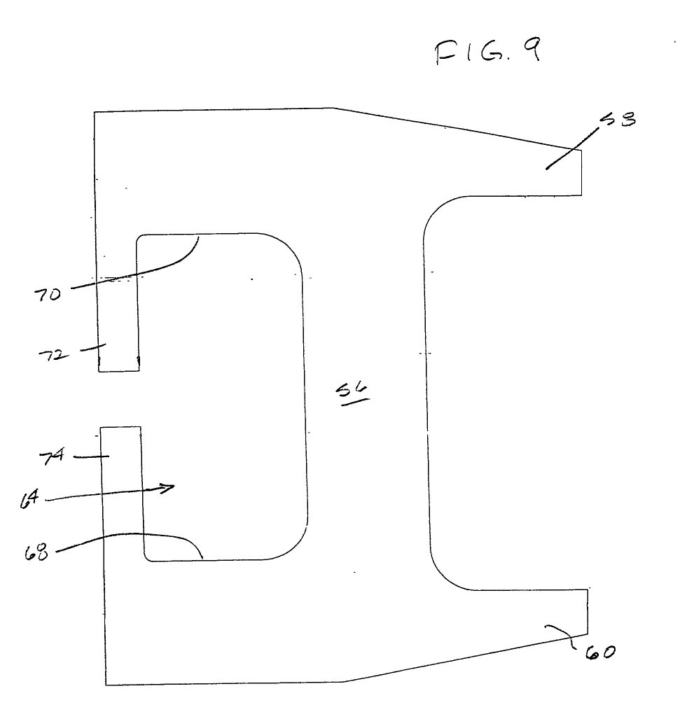

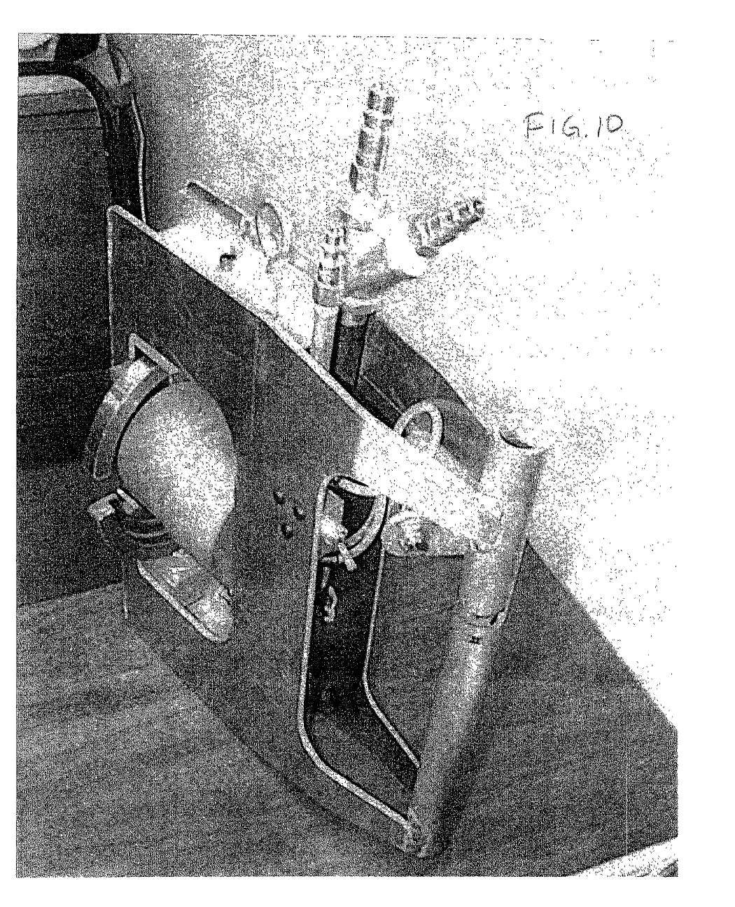

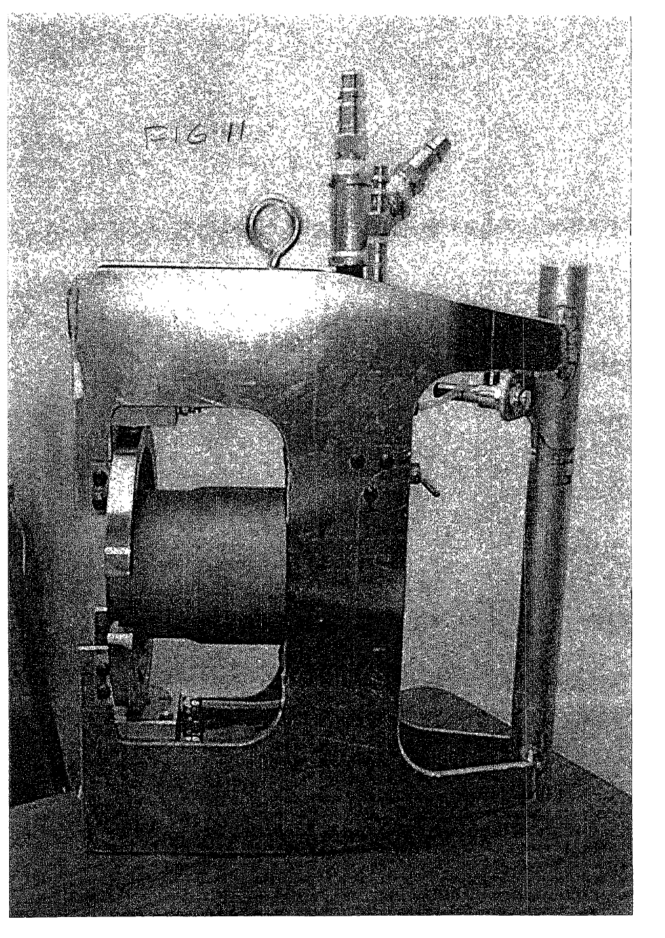

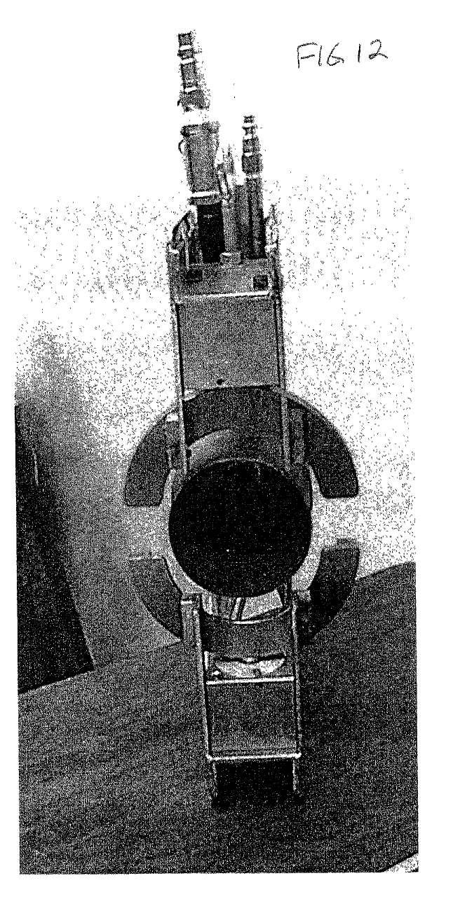

Referring to the drawings, a conventional injection molding press 10 for molding flexible tubular members 12 having convolutions 14 is shown in FIG. 1. FIG. 1 illustrates a person 16 employing the part removal tool 18 of the present invention for the purpose of removing part 12 from the mold core 20.

Injection molding press 10 comprises a cabinet 22 having an open front side 24. Upper and lower mold halves 26 and 28 are mounted on columns 30 inside the cabinet. A shuttle mechanism 32 mounted on slides 34 employing cam wheels at the sides of the shuttle mechanism make it possible to slide the mold core 20 into and out of alignment with mold cavities in the upper and lower mold halves or plates. In FIG. 1, the mold core, which is mounted on the end of shaft 36 is shown in an extended position. The mold core can be moved into alignment with mold cavities in the upper and lower mold plates by pushing the mold core inwardly, in a conventional manner.

Products are molded in the mold core in a conventional manner. Typically these products are rubber when used in automotive applications. Other moldable resins could be employed. When the mold core is moved inwardly into the cabinet in alignment with the mold cavities, the press is closed by raising lower plate 28 upwardly until it engages shuttle mechanism 32, and then both the lower plate and shuttle mechanism are moved upwardly until they engage the upper plate. At that time, the mold is injected with a moldable resin such as rubber and the part is formed.

After the part has been formed, the plates are lowered and the mold core extended to the position shown in FIG. 1. At that point, the product is removed from the mold core employing the product removal tool 18 of the present invention.

Product removal tool 18 is suspended by hook 19 on a cable 38 in a spring wound reel 40 which is in turn mounted on a boom 42 pivotally mounted by a pivot fixture 44 on the top of the cabinet for the press. The boom can be pivoted into operational position shown in FIG. 1 for removal of the part from the mold core. When the mold core is retracted into the press and the part is being formed, the boom is pivoted out of the way to the position shown in phantom FIG. 42′. The spring wound reel exerts enough spring pressure on the cable to neutralize the weight of the part removal tool and thus makes it possible to raise and lower the tool without lifting the weight of the tool.

Part removal tool 18 is connected to various electrical and pneumatic cables and tubes 46 which are connected by quick disconnect fittings 48 and plugs 50 for quickly connecting and disconnecting the tool from the electrical and pneumatic supply lines. The supply lines are wound around the boom and then eventually extend to a source of electrical power and a source of pressurized air that is available in the plant where the manufacturing operation is taking place.

The construction of product removal tool 18 is shown in FIGS. 2, 3, and 7-9. Part removal tool 18 comprises an enclosed housing 52 that surrounds and protects the pneumatic and electrical cables and tubes 46 that extend inwardly into the interior of the tool. This protects the cables and tubes from damage during operation of the tool. Housing 52 comprises a pair of spaced plates 54 on opposite sides of the tool. The spaced plates have a vertical center member 56 and inwardly and rearwardly extending upper and lower flanges 58 and 60 at a rear side. A tubular handle 62 is welded to the ends of flanges 58 and 60. The front portion of plate 56 includes a central enlarged recess 64 in which an air injection cup 66 is mounted. An important feature of recess 64 is that upper and lower edges 68 and 70 are spaced a substantial distance apart so that air injection cups of various sizes will fit in the recess.

Upper and lower semicircular clamp elements 72 and 74 are positioned adjacent a front open end 76 of the air injection cup. The semicircular clamp elements are mounted for vertical movement on upper and lower drive cylinders 78 and 80. They ride on nylon or brass guide plates 82 and 84 mounted on flanges 86 and 88 at the mouth 90 of the part removal tool. The clamp elements are removably threaded on the ends of cylinder rods of the drive cylinders. Each clamp element is shaped to fit on a particular cup and mold core, and the clamp elements are changed for each part having a different size or shape, which may or may not be circular in cross section.

Side plates 52 are formed of a durable metal, preferably aircraft aluminum.

Plates 52 are spaced apart by spacers in the form of U-shaped channels 92 and 94 at upper and lower sides of the plates. The side plates and upper and lower channels thus provide a protective external housing for a number of delicate pneumatic and electrical components that are mounted in the open interior of the housing. A mounting block 96 is mounted between the plates at an inward end of air injection cup 66 and serves as an additional plate spacer and as a means for mounting a manifold 98 for injecting air through the air injection cup (see FIG. 7). The air injection cup desirably is bolted on the manifold. Preferably, all cups are fabricated with the same size of fitting for mounting the cup on the same manifold.

The details of the electrical and pneumatic circuitry of the product removal tool of the present invention are shown in FIGS. 3 and 7. The manner in which these components function for removing a part from the mold core 20 is shown in FIG. 5. As shown in FIG. 5, after a part has been molded, end 76 of air injection cup 66 is wedged between an end 100 of part 12 and a distal end of mold core 20. It should be noted that end 76 of the air injection cup has a beveled forward edge that facilitates wedging the air injection cup between the part and the mold core. Also, a forward part 102 of the air injection cup has a thinner wall than a rearward portion 104 of the air injection cup, thus further facilitating the wedging of the air injection cup between the part and the mold core.

As shown in FIG. 5, after the air injection cup has been wedged between the part and the mold core, clamps 72 and 74 are actuated so they clamp the end of the product tightly to the walls of the air injection cup in a substantially sealed relationship. At that point pressurized fluid, preferably air, is injected through an inlet tube 106 into manifold 98. Thereafter, the air enters the open interior of the cup 110 through openings 112 positioned around the peripheral edge of the end of the cup. The pressurized air in the cup is forced between the cup and the mold core into the space 116 between the molded product 12 and the mold core 20. The product is then, in effect, blown up to the position shown in FIG. 5, wherein convolutions 14 in the part separate from convolutions 118 in the mold core. The part can then be pulled off the mold core by pulling handle 62 in a direction away from the mold core.

Referring to FIG. 7, the part removal tool is preferably operated by pneumatic air pressure, which is generally available in the plant in which the molding operation takes place. A source of pressurized air 120 is designated schematically in FIG. 7. Air pressure is provided to the air injection cup manifold through an inlet conduit 122. A fitting 124 provides two inlets into conduit 122. One inlet 126 is a low pressure inlet that is connected via a pressure regulator 128 to source 120. The line air pressure available from source 120 varies from plant to plant. For exemplary purposes, a line pressure of approximately 140 pounds per square inch (psi) is typical. In such a situation, pressure regulator 128 may reduce the pressure to low pressure conduit and inlet port 126 to approximately 90 psi.

An inlet conduit 130 is used for providing extra pressure to the air injection cup manifold when additional inflation pressure is necessary to dislodge the part from the mold core. Conduit 130 does not extend through a pressure regulator and thus receives full line pressure and provides a “turbo” pressure for releasing the product from the mold.

Another pressure line 131 extends to a one quarter inch inlet line 132 that actuates the clamps of the present invention. Line 132 extends through a T connection 134 into a solenoid controlled valve 136. Solenoid valve is controlled by electrical toggle switch 138. When toggle switch 138 is in the down position, as shown in FIG. 7, air is directed through outlet fitting 140. This directs air through conduits 142 and 144 to actuators 78 and 80 and causes the actuators to retract the clamps and hold them in a retracted position. When toggle switch 138 is moved to an upward position, air is redirected to outlet fitting 146, which causes air to be directed through lines 148 and 150 to fittings 152 and 154 on actuators 80 and 78. This causes the actuators to bring the clamps together and clamp the product on the air injection cup. Thus, the clamping mechanism positively moves the clamps between their closed and open positions and holds them in the positions.

Pressurized air flow to the air injection pump cup manifold is controlled by a pneumatic air valve 156 in line 126 and is controlled by an electrical solenoid valve 158 in line 130. Pneumatic control valve 156 is actuated through air conduit 160, which is connected to a thumb-operated button 162 on handle 62. When button 162 is depressed, valve 164 is opened, permitting pressurized air flow from T fitting 136 through conduit 166 and then through conduit 160 to valve 156. This opens the valve and admits pressurized air through conduit 126 into the air injection cup manifold, which in turn permits pressurized air at the lower pressure (e.g. 90 psi) into the space between the part and the mold core.

When additional pressure is necessary, an electrical switch in the nature of actuator button 170 actuates electric solenoid 158 through electrical cable 172. When electrical solenoid is actuated, full line pressure is introduced into air injection pump manifold 98 in addition to the reduced line pressure available through the low pressure inlet. This causes an additional boost of air volume and air pressure in the air injection cup and this provides additional force for removing the part from the mold core.

It can be seen from the foregoing description that all of the pneumatic and electrical components are housed in a protected fashion in the interior of the part removal tool housing, protecting the parts from accidental injury. This is an important feature of the present invention. The side plates of the housing are formed of durable metal plates, preferably aluminum, which are welded to channels 92 and 94, mounting block 96, and handle 62 and are not welded to other components. Welding tends to weaken aluminum, and the present invention structure maximizes the strength of the aluminum.

Another feature of the invention is the wide mouth employed for the air injection cup. The wide mouth created by the recessed or cutaway portion 64 having lower and upper edges 68 and 70 provides substantial distance between the outer periphery of the air injection cup and the housing. The air injection cup is simply bolted to the housing, so it can be removed and replaced with a larger or smaller cup at will, and there is a wide variety in sizes of cups that can be employed in the large amount of space provided in this housing. In the past, part removal tools have required a separate tool for virtually each mold. With the present invention, one size fits most applications. Indeed, with three different sizes of air injection tools, these tools can accommodate virtually every moldable part that is being made in the fashion described in this invention. This is quite a savings over prior tools.

An alternative embodiment 200 is shown in FIG. 6. Most of the parts are the same as the prior embodiment, except that the housing is fitted with a pressure cylinder 202 that drives an extendable core bar 204 outwardly and inwardly through the air injection cup. A somewhat different handle assembly 206 is fitted to the housing in order to provide room for cylinder 202. Handle 206 includes spaced vertical members 208 connected at upper and lower portions by crossbars 210 and 212. Central vertical members 214 and 216 are connected to the side plates in the same manner as handle 62 of the previous embodiment.

The core bar feature of this invention provides an extra pulling force for pulling the product off the end of the mold core. A switch 218 actuates pressure cylinder 202 and extends core bar 204 outwardly into contact with an indented portion 220 in the end of mold core 222. When core bar 204 is extended into contact with the mold core 222, this forces the mold core away from the product removal tool and tends to pull the product removal tool and attached product away from the mold core. This feature of the invention is useful in molds where product removal is especially difficult.

It should be understood that the foregoing is merely exemplary of the preferred practice and that various changes and modifications may be made in the arrangements and details of construction of the embodiments disclosed herein without departing from the spirit and scope of the present invention.

I claim:

1. A part removal tool for removing a molded elastic tubular part from a mold core comprising:
a housing having protective side plates spaced on each side of an open interior, the housing having an open front end;
a handle mounted to the plates at a rear end of the tool;
an enlarged recess in the plates adjacent the front end of the tool such that a number of part removal cups having substantially different outer dimensions can be inserted in the recess;
a part removal cup manifold mounted between the plates at a rear end of the recess, the manifold having an inlet for pressurized gas and one or more outlets for pressurized gas;
a part removal cup removably mounted in the housing in the enlarged recess between the plates, the cup having an open front end facing outwardly from an open interior toward the open front end of the housing, the part removal cup having relatively thin peripheral sidewalls surrounding the open front end such that the sidewalls conform with and fit closely over a specified mold core, the part removal cup having a rear end mounted in the housing in sealed relationship with the manifold outlet, the rear end having one or more openings therein that provide sealed communication between the manifold outlet and the open interior of the cup;
a clamp movably and removably mounted in the housing adjacent the open end of the part removal cup and having an open position, wherein the clamp is spaced away from the cup sufficiently that the cup can be inserted between a molded product and a mold core, and a closed position, wherein the clamp clamps an end of the product on the cup after the cup has been inserted on the mold core, the clamp having a clamping surface compatible with the adjacent exterior surface of the part removal cup;
clamp actuating means for opening and closing the clamp; and
cup air actuating means for injecting pressurized gas through the manifold to the cup to separate a clamped part from a mold core.

2. A part removal tool according to claim 1 wherein the side plates are spaced apart by spacers positioned between the plates, the plates having an open front edge at a front end of the housing, the enlarged recess in the side plates extending rearwardly in the plates from an edge opening in the front edge to an enlarged opening rearwardly from the edge opening, the cup manifold being positioned adjacent a rear side of the enlarged opening, the enlarged openings in the plates being sufficiently large that a plurality of different sized part removal cups can fit into the open interior of the housing through the enlarged openings in the side plates, the cups being removably mounted in the enlarged opening with a rear end being in sealed communication with the pressurized gas manifold outlet and with the front end facing outwardly in through the open front end of the housing, the clamps having clamping elements mounted for transverse movement on opposite sides of the open edge.

3. A part removal tool according to claim 2 wherein the clamping mechanism comprises transverse slides mounted in the housing on opposite sides of the housing open front end, with one clamping element being removably and slidably mounted on each slide, the clamping elements including contoured opposed clamping surfaces shaped to sealingly clamp the molded product on the part removal cup, the clamping elements being removable and replaceable with different clamping elements shaped to accommodate different sizes and shapes of cups.

4. A part removal tool according to claim 1 wherein the tool includes actuators controlled by one or more of a plurality of gas and electrical switches, which are mounted in shielded positions in the open interior of the housing, the tool including interior gas and electrical conduits leading from quick release fittings at the exterior of the housing to the shielded switches and actuators in the housing, the switches and actuators thus being protected while permitting the tool to be connected and disconnected easily with quick release fittings.

5. A part removal tool according to claim 1 wherein the handle comprises a vertical handle member attached to the side plates by means of spaced upper and lower flanges extending from a rear edge thereof, switches for controlling tool operation being mounted in the tool so as to be accessible to a hand while gripping the handle member.

6. A part removal tool according to claim 1 wherein the protective side plates are formed of a strong, lightweight aluminum plate material.

7. A part removal tool according to claim 1 and further comprising:
a part ejection rod mounted in the housing for reciprocal movement in a direction toward the open front end of the part removal cup;
an ejection rod cylinder for reciprocating the rod between retracted and extended positions, the cup being insertable on a mold core when the rod is retracted, the mold core being engaged by the rod and moved away from the cup so as to remove a molded part from the mold core when the rod is extended and the molded part clamped on the part removal cup; and
actuating means for actuating the ejection rod drive cylinder.

8. A part removal tool according to claim 1 wherein each of a plurality of different part removal cups is mounted on the manifold outlet by a common sized fitting that fits on the manifold outlet, the shapes of the front ends of the cups and the clamp varying among the cup so as to fit on and clamp mold core of different sizes and shapes.
